(19) United States
(12) Patent Application Publication
(10) Pub. No.: US 2026/0144270 A1
(43) Pub. Date: May 28, 2026

(54) COFFEE PRODUCT

(71) Applicant: Koninklijke Douwe Egberts B,V., Utrecht (NL)

(72) Inventors: Casper Horn, Utrecht (NL); Borja Roman Corrochano, Utrecht (NL); Javier Silanes Kenny, Utrecht (NL)

(21) Appl. No.: 19/122,655

(22) PCT Filed: Oct. 18, 2023
(86) PCT No.: PCT/EP2023/079060

§ 371 Date: Apr. 18, 2025

(30) Foreign Application Priority Data
Oct. 20, 2022 (GB) 2215515.4

(51) Int. Cl. A23F 5/14; A23F 5/40

(52) U.S. Cl. CPC A23F 5/14; A23F 5/405

(57) ABSTRACT

The present invention relates to a coffee product comprising roast and ground coffee particles coated with one or more beverage ingredient powders and a sugar. The present invention also relates to a process for manufacturing a coffee product comprising the steps of: a) spraying a sugar solution onto a dry mixture comprising roast and ground coffee particles and one or more beverage ingredient powders to coat the roast and ground coffee particles with one or more beverage ingredient powders and a sugar. b) mixing the mixture formed in step a); and c) drying the coated roast and ground coffee particles to form a coffee product comprising roast and ground coffee particles coated with one or more beverage ingredient powders and a sugar.

### TECHNICAL FIELD OF THE INVENTION

The present invention relates to a coffee product. In particular, the present invention relates to a coffee product comprising roast and ground coffee particles coated with one or more beverage ingredient powders and a sugar and to a process for manufacturing the coffee product.

### Background to the Invention

When preparing a beverage containing a number of powdered ingredients, it is known in the art, that powder solubility can be a problem, resulting in a drink with grainy texture or weak concentration and an undesirable leftover residue of wetted powder.

A number of options exist to the skilled person when faced with a problem of powder solubility, including, varying the type or blend of solvent, increasing the temperature or volume of the solvent, the introduction of shear or increasing powder-solvent contact time for example. In some applications, such as containers for use in beverage preparation machines, it is known that several of these levers for adjusting solubility are restricted/limited or unavailable.

As such, alternative methods may be used such as the addition of inserts to separate the beverage powder ingredients and ensure sufficient solubility during brewing. However, the use of such inserts adds additional costs and waste to the product.

Additionally, it is known from at least US2014/19944A1 and EP223013A1 to produce roast and ground coffee coated with one or more beverage ingredient powders. However, such processes typically result in coffee products which exhibit high level of fines, low density, low solubility and low amounts of brew solids in the resulting beverage.

Therefore, it is an aim of the present invention to provide a coffee product containing one or more beverage ingredient powders with improved solubility and/or reduced cost and/or reduced waste.

It is an aim of the present invention to provide a coffee product that leaves significantly less undissolved powder after preparation with water, compared to the prior art.

It is a further aim of the present invention to provide an improved process for manufacturing a coffee product for use in a beverage ingredient container, such as a sachet, soft pad, semi-rigid pad, rigid pad, capsule, disc and/or pod.

It also an aim of embodiments of the present invention to provide an improved coffee product having reduced level of fines, increased density, improved solubility and/or increased amount of brew solids in the resulting beverage.

It is also an aim of embodiments of the invention to overcome at least one problem of the prior art, whether expressly disclosed herein or not.

### SUMMARY OF THE INVENTION

According to a first aspect of the present invention there is provided a coffee product comprising roast and ground coffee particles coated with one or more beverage ingredient powders and a sugar.

The inventors found that by coating a roast and ground coffee particle with one or more further beverage ingredient powders and a sugar, the product exhibited improved solubility during brewing. This means that the coffee product may be included in a beverage ingredient container without the presence of inserts or any other additional method to improve solubility whilst still providing a brew without grainy texture or weak concentration and/or an undesirable leftover residue of wetted powder.

The sugar may be selected from the group comprising a monosaccharide, disaccharide and/or an oligosaccharide. The sugar may be one or more sugars selected from the group comprising glucose, sucrose, fructose, galactose, lactose, molasses and/or maltose.

The one or more beverage ingredient powders may comprise a powder selected from an instant coffee powder, a chocolate beverage powder, a milk powder, dairy creamer and a non-dairy creamer powder. In preferred embodiments, the beverage ingredient powder comprises fat and in more preferred embodiments it is a fat-containing powder selected from a chocolate beverage powder, a milk powder and a non-dairy creamer powder.

“Non-dairy creamer” refers to a product that replicates the mouthfeel and/or flavour of dairy milk and comprises a fat or oil, and optionally an emulsifier, a protein and/or a sweetener. The fat is typically a non-dairy fat, preferably a vegetable fat, such as coconut oil, olive oil, grapeseed oil, cocoa butter, palm oil, palm kernel oil, sunflower oil, and rapeseed oil. Any appropriate food grade fat/oil, protein and sweetener may be used in the composition. The non-dairy creamer may comprise a dairy protein, such as sodium caseinate. “Dairy creamer” refers to products known commercially as ‘Dairy creamer’. They are typically compositions that comprise at least a fat and optionally an emulsifier, a protein and/or a sweetener. Any appropriate food grade protein and sweetener may be used in the composition. Typically, the fat is a dairy fat and the protein is a dairy protein, such as sodium caseinate. “Chocolate powder” refers to any powder comprising cocoa. It may further comprise additional ingredients such as a milk powder, a fat; a sweetener, bulking agent, drying agent, anti-caking agent; etc. The fat may be cocoa butter, cocoa butter equivalent, cocoa butter substitute or any animal or plant derived fat. The sweetener may be selected from a carbohydrate-based sweetener or a non-carbohydrate based sweetener. The carbohydrate-based sweetener may be one or more selected from the group comprising a sugar such as fructose, glucose, maltose, sucrose, lactose, dextrose, high fructose corn syrup or a sugar substitutes like e.g. polyols such as sorbitol, mannitol, xylitol or combinations thereof, maltodextrins, dried glucose syrups, malt extracts, starches, trehalose, raftiline, raftilose, galactose, maltose, oligosaccharides, honey powders, and mixtures of same. The non-carbohydrate based sweetener may be an artificial sweetener like e.g. Splenda®, Acesulfame K®, or aspartame, and mixtures of the same. The non-carbohydrate based sweetener may be a natural sweetener, such as stevia.

“Milk powder” refers to a composition that comprises at least milk from animal sources, such as, goats, cows, sheep, etc., and milk alternatives derived from plant sources, including those derived from nuts; oats; seeds; drupes, grains, including, but not limited to, almond, cashew, soybean, coconut, hemp, rice, horchata, peanut. It may be derived from full fat, semi-skimmed, skimmed, heat treated, homogenised milk etc. In particular, it may be full fat milk powder, semi skimmed milk powder and/or skimmed milk powder.

In embodiments in which the beverage ingredient powder comprises fat, it comprises at least 5%, 6%, 7%, 8%, 9% or 10% wt fat and/or no more than 70%, 60%, 50%, 30%, or 20% wt fat, and/or between 5% wt and 25% wt, 70% wt fat, preferably between 10%-25% wt; 5%-20% wt or 10%-20% wt fat by weight. In embodiments, where the beverage ingredient powder is chocolate powder; it comprises at least 4%, 4.5%, 5%, 5.5% or 6% wt fat and/or no more than 9%, 8.5%, 8%, 7.5% or 7% wt fat and/or between 4%-9% wt; 4%-8% wt; 4%-7% wt; 5%-9% wt; 5%-8% wt or 6% 8% wt fat. In further embodiments, where the beverage ingredient powder is a milk powder, it comprises at least 10%, 11% or 12% wt and/or no more than 30%, 25%, 22% or 20% wt fat and/or between 10%-25% wt, 10%-20% wt, 12%-25% wt or 12% 20% wt fat. In further embodiments, where the beverage ingredient powder is a dairy creamer powder or a non-dairy creamer powder, it comprises at least 25% wt and/or no more than 70% wt fat and/or between 25%-70% wt fat.

Beverage powders that contain fat in such quantities as described here are known in the art to have lower solubility in water. Embodiments of the invention that have such fat content have the particular advantage of sufficient solubility to create a beverage with adequate solids content and low beverage ingredient residues.

The coffee product may comprise roast and ground coffee in an amount of at least 1 wt. %, 2 wt. %, 3 wt. %, 4 wt. %, 5 wt. %, 6 wt. %, 7 wt. %, 8 wt. %, 9 wt. %, 10 wt. %, 11, 12 wt. %, 13 wt. %, 14 wt. %, 15 wt. %, 20 wt. %, 25 wt. %, 30 wt. %, 35 wt. %, 40 wt. %, 45 wt. %, 50 wt. %, 60 wt. %, 65 wt. %, 70 wt. %, or 75 wt. %, by weight of the coffee product. The coffee product may comprise roast and ground coffee in an amount of no more than 99wt. %, 98wt. %, 96wt. %, 95wt. %, 94wt. %, 92wt. %, 90 wt. %, 88 wt. %, 86 wt. %, 85 wt. % 80 wt. %, 75 wt. %, 70 wt. %, 65 wt. %, 60 wt. % or no more than 55 wt. % by weight of the coffee product.

The coffee product may comprise roast and ground coffee in an amount of from 1-99 wt. %, 1-95 wt. %, 1-90 wt. %, 1-85 wt. %, 10-85 wt. %, 15-75 wt. %, 15-70 wt. %, 15-65 wt. %, 20-65 wt. %, 25-65 wt. %, 30-65 wt. %, 35-65 wt. %, 35-60 wt. %, 40-60 wt. %, or 40-55 wt. % by weight of the coffee product.

In some embodiments, the roast and ground coffee may be derived from pure Arabica whole coffee beans.

In some embodiments, the roast and ground coffee may be derived from pure Robusta whole coffee beans.

In other embodiments, the roast and ground coffee may be derived from a mixture of Arabica and Robusta whole coffee beans.

The coffee product may comprise one or more beverage ingredient powders in an amount of at least 1 wt. %, 2 wt. %, 3 wt. %, 4 wt. %, 5 wt. %, 6 wt. %, 7 wt. %, 8 wt. %, 9 wt. %, 10 wt. %, 11, 12 wt. %, 13 wt. %, 14 wt. %, 15 wt. %, 20 wt. %, 25 wt. %, 30 wt. %, 35 wt. %, 40 wt. %, 45 wt. % or at least 50 wt. % by weight of the coffee product. The coffee product may comprise one or more beverage ingredient powder in an amount of no more than 60 wt. %, 55 wt. %, 50 wt. %, 45 wt. %, 40 wt. %, 35 wt. %, 30 wt. %, 25 wt. %, 20 wt. %, 15 wt. % or no more than 10 wt. % by weight of the coffee product.

The coffee product may comprise one or more beverage ingredient powders in an amount of from 1-55 wt. %, 1-50 wt. %, 1-45 wt. %, 1-40 wt. %, 1-35 wt. %, 1-30 wt. %, 1-25 wt. %, 5-55 wt. %, 10-50 wt. %, 15-45 wt. %, 20-40 wt. %, 25-45 wt. %, or 30-40 wt. % by weight of the coffee product.

The coffee product may comprise sugar in an amount of at least 1 wt. %, 2 wt. %, 3 wt. %, 4 wt. %, 5 wt. %, 6 wt. %, 7 wt. %, 8 wt. %, 9 wt. %, 10 wt. %, 11, 12 wt. %, 13 wt. %, 14 wt. %, 15 wt. %, or at least 20 wt. % by weight of the coffee product. The coffee product may comprise sugar in an amount of no more than 60 wt. %, 55 wt. %, 50 wt. %, 45 wt. %, 40 wt. %, 35 wt. %, 30 wt. %, 25 wt. %, 20 wt. %, 15 wt. % or no more than 10 wt. % by weight of the coffee product.

The coffee product may comprise sugar in an amount of from 1-30 wt. %, 1-25 wt. %, 5-25 wt. %, 10-25 wt. %, or 15-25 wt. % by weight of the coffee product.

The coated roast and ground coffee particles of the coffee product may have a surface covered by at least 10%, 20%, 30%, 40% 50%, 55%, 60%, 65%, 70%, 75%, 80%, 85%, 90%, or 99% of the one or more beverage ingredient powders and a sugar.

Preferably, substantially 100% of the surface of the coated roast and ground coffee particles is covered with of the one or more beverage ingredient powders and a sugar.

The coated ground coffee particles may have a coating of one or more beverage ingredient powders and a sugar with a mean thickness of at least 0.1 micron, 0.5 microns, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64 or 65 microns.

The coated ground coffee particles may have a coating of one or more beverage ingredient powders and a sugar with a mean thickness of no more than 250, 245, 240, 235, 230, 225, 220, 215, 210, 205, 200, 195, 190, 185, 180, 175, 170, 165, 160, 155, 150, 145, 140, 135, 130, 125 120, 115, 110, 105, 100, 95, 90, 85, 80, 75, 70, 65, 60, 55 or 50 microns.

In some embodiments, the coated ground coffee particles may have a coating of one or more beverage ingredient powders and a sugar with a mean thickness of from 1 microns to 250 microns, 5 microns to 200 microns, 10 microns to 150 microns, 10 microns to 125 microns, 10 microns to 100 microns, 10 microns to 75 microns, 15 microns to 75 microns, 20 microns to 70 microns, 25 microns to 65 microns, 30 microns to 60 microns, 35 microns to 60 microns or 40 microns to 55 microns.

Preferably, the thickness of the coating is uniform over the surface of the roast and ground coffee particles.

The coffee product may have a mean density of at least 250, 300, 350 g/l or 400 g/l and/or no more than 850, 650 or 600 g/l and/or between 250-850 g/l; 350-850 g/l; 250-600 g/l or 350-600 g/l.

In some embodiments, the coffee product may have a mean density of at least 200 g/l, 205 g/l, 210 g/l, 215 g/l, 220 g/1, 225 g/l, 230 g/l, 235 g/1, 240 g/l, 245 g/l, 250 g/l, 255 g/l, 260 g/l, 265 g/l, 270 g/l, 275 g/l, 280 g/l, 285 g/l, 290 g/l, 295 g/l, 300 g/l, 305 g/1, 310 g/l, 315 g/l, 320 g/l, 325 g/l, 330 g/l, 335 g/l, 340 g/l, 345 g/l, 350 g/l, 355 g/l, 360 g/l, 365 g/l, 370 g/l, 375 g/l, 380 g/l, 385 g/l, 390 g/l, 395 g/l, or at least 400 g/l.

The coffee product may have a mean density of no more than 900 g/l, 895 g/l, 890 g/l, 885 g/l, 880 g/l, 875 g/l, 870 g/l, 865 g/l, 860 g/l, 855 g/l, 850 g/l, 845 g/l, 840 g/l, 835 g/l, 830 g/l, 825 g/l, 820 g/l, 815 g/l, 810 g/l, 805 g/l, 800 g/l, 795 g/l, 790 g/l, 785 g/l, 780 g/l, 775 g/l, 770 g/l, 765 g/l, 760 g/l, 755 g/l, 750 g/l, 745 g/l, 740 g/l, 735 g/l, 730 g/l, 725 g/l, 720 g/l, 715 g/l, 710 g/l, 705 g/l, 700 g/l, 695 g/l, 690 g/l, 685 g/l, 680 g/l, 675 g/l, 670 g/l, 665 g/l, 660 g/l, 655 g/l, 650 g/l, 645 g/l, 640 g/l, 635 g/l, 630 g/l, 625 g/l, 620 g/l, 615 g/l, 610 g/l, 605 g/l, 600 g/l, 595 g/l, 590 g/l, 585 g/l, 580 g/l, 575 g/l, 570 g/l, 565 g/l, 560 g/l, 555 g/l, 550 g/l, 545 g/l, 540 g/l, 535 g/l, 530 g/l, 525 g/l, 520 g/l, 515 g/l, 510 g/l, 505 g/l, or no more than 500 g/l.

The coffee product may have a mean density of from 225-625g/1, 230-620 g/l, 235 -615 g/l, 240 -610 g/l, 245-605 g/l, 250-600 g/l, 255-595 g/l, 260-590 g/l, 265-585 g/l, 270-580 g/l, 275-575 g/l, 280-570 g/l, 285-565 g/l, 290-560 g/l, 295-555 g/l, 300-550 g/l, 305-545 g/l, 310-540 g/l, 315-535 g/l, 320-530 g/l, 325-525 g/l, 330-520 g/l, 335-515 g/l, 340-510 g/l, 345-505 g/l, 350-500 g/l, 355-495 g/l, 360-490 g/l, 365-485 g/l, 370-480 g/l, 375-475 g/l, 380-470 g/l, 385-465 g/l, 390-460 g/l, 395-455 g/l, 400-450 g/l, 400-600 g/l, 405-595 g/l, 410- 590 g/l, 415-585 g/l, 420-580 g/l, 425-575 g/l, 430-570 g/l, 435-565 g/l, 440-560 g/l, 445-555 g/l, 450-550 g/l, 400-600 g/l, 405-595 g/l, 410-590 g/l, 415-585 g/l, 420-580 g/l, 425-575 g/l, 430-570 g/l, 435-565 g/l, 440-560 g/l, 445-555 g/l, 450-550 g/l, 450-545 g/l, 450-540 g/l, 450-535 g/l, 450-530 g/l, or from 450-525 g/l.

Densities within these limits provide the additional advantage of optimised pack density within the confines of a machine insertable container, such as a capsule.

The coffee product may have a median or mean particle size of at least 200, 210, 220, 225, 230, 240, 250, 260, 270, 275, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, or at least 600 microns.

The coffee product may have a median or mean particle size of no more than 1000, 980, 970, 960, 950, 940, 930, 920, 910, 900, 890, 880, 870, 860, 850, 840, 830, 820, 810, 800, 790, 780, 770, 760, 750, 740, 730, 720, 710, 700, 690, 680, 670, 660, 650, 640, 630, 620, 610, 600, 590, 580, 570, 560, 550, 540, 530, 520, 510, 500, 490, 480, 470, 460, 450, 440, 430, 420, 410, or no more than 400 microns.

The coffee product may have a median or mean particle size of from 200-600, 200-1000, 200-990, 200-980, 200-970, 200-960, 200-950, 200-940, 200-930, 200-920, 200-910, 200-900, 200-890, 200-880, 200-870, 200-860, 200-850, 200-840, 200-830, 200-820, 200-810, 200-800, 210-790, 220-780, 230-770, 240-760, 250-750, 260-740, 270-730, 280-720, 290-710, 300-700, 310-690, 320-680, 330-670, 340-660, 350-650, 360-640, 370-630, 380-620, 390-610, 400-600, 400-590, 400-580, 400-570, 400-560, 400-550, 400-540, 400-530, 400-520, 400-510, 400-500, 400-490, 400-480, 400-470, 400-460, 400-450, 400-500, 405-490, 410-480, 415-470, 420-460, 425-450, or from 430-440 microns.

Median particle size may be measured by laser diffraction method (e.g. Helos/KR (Sympatec) system measured with R7 lens).

The coffee product may have an amount of fine particles (“fines”, particles less than 90 microns, sometimes described as Q90) of no more than 20, 19, 18, 16, 14, 12, 10, 9, 8, 7, 6, 5, 4, 3, 2, 1.9, 1.8, 1.7, 1.6, 1.5, 1.4, 1.3, 1.2, 1.1, 1, 0.9, 0.8, 0.7, 0.6, 0.5, 0.4, 0.3% of the coffee product. In some embodiments the amount of fines is between 0-20%, 0-15%, 0-10%, 0-5%, 0-4%, 0-3%, 0-2%, 0-1.9%, 0-1.8%, 0-1.7%, 0-1.6%, 0-1.5%, 0-1.4%, 0-1.3%, 0-1.2%, 0-1.1%, 0-1.0%, 0-0.9%, 0-0.8%, 0-0.7%, 0-0.6%, 0-0.5%, 0-0.4%, 0-0.3%, %, 0.1-1.0%, 0.1-0.9%, 0.1-0.8%, 0.1-0.7%, 0.1-0.6%, 0.1-0.5%, 0.1-0.4%, 0.1-0.3% The fines may be measured, for example, by laser diffraction particle size measurement (e.g. Helos/KR (Sympatec) system measured with R7 lens).

Embodiments with such levels of fines have the particular advantage of improved solubility over coffee products with alternative levels of fines. Moreover, the low level of fines prevents blocking of a coffee container.

According to a second aspect of the present invention, there is provided a process for manufacturing a coffee product comprising the steps of:
a) spraying a sugar solution onto a dry mixture comprising roast and ground coffee particles and one or more beverage ingredient powders to coat the roast and ground coffee particles with one or more beverage ingredient powders and a sugar.
b) mixing the mixture formed in step a); and
c) drying the coated roast and ground coffee particles to form a coffee product comprising roast and ground coffee particles coated with one or more beverage ingredient powders and a sugar.

Steps a) and b) may be carried out simultaneously.

In some embodiments, steps a), b) and c) may be carried out simultaneously.

Alternatively, steps a), b) and c) may be carried out sequentially.

The inventors surprisingly found that by spraying a sugar solution onto a dry mixture of roast and ground coffee particles and one or more beverage ingredient powders, the beverage ingredient powders and sugar were able to form a uniform coating on the roast and ground coffee particles.

The sugar solution may be an aqueous solution comprising a monosaccharide, disaccharide and/or an oligosaccharide. Preferably, the sugar solution may be an aqueous solution comprising glucose, sucrose, fructose, galactose, lactose and/or maltose.

The dry mixture may comprise roast and ground coffee in an amount of from at least 1 wt. %, 2 wt. %, 3 wt. %, 4 wt. %, 5 wt. %, 6 wt. %, 7 wt. %, 8 wt. %, 9 wt. %, 10 wt. %, 11, 12 wt. %, 13 wt. %, 14 wt. %, 15 wt. %, 20 wt. %, 25 wt. %, 30 wt. %, 35 wt. %, 40 wt. %, 45 wt. %, 50 wt. %, or at least 60 wt. %, by weight of the dry mixture. The dry mixture may comprise roast and ground coffee in an amount of no more than 99 wt. %, 98 wt. %, 96 wt. %, 95 wt. %, 94 wt. %, 92 wt. %, 90 wt. %, 88 wt. %, 86 wt. %, 85 wt. %, 80 wt. %, 75 wt. %, 70 wt. %, 65 wt. % or no more than 60 wt. % by weight of the dry mixture.

The dry mixture may comprise roast and ground coffee in an amount of from 1-99 wt. %, 1-95 wt. %, 1-90 wt. %, 1-85 wt. %, 1-80 wt. %, 1-75 wt. %, 1-70 wt. %, 1-65 wt. %, 10-65 wt. %, 15-65 wt. %, 20-65 wt. %, 25-65 wt. %, 30-65 wt. %, 35-65 wt. %, 40 -65 wt. %, or 45-55 wt. % by weight of the dry mixture.

The dry mixture may comprise one or more beverage ingredient powders in an amount of at least 1 wt. %, 2 wt. %, 3 wt. %, 4 wt. %, 5 wt. %, 6 wt. %, 7 wt. %, 8 wt. %, 9 wt. %, 10 wt. %, 11, 12 wt. %, 13 wt. %, 14 wt. %, 15 wt. %, 20 wt. %, 25 wt. %, 30 wt. %, 35 wt. %, 40 wt. %, 45 wt. % or at least 50 wt. % by weight of the dry mixture. The dry mixture may comprise beverage ingredient powder in an amount of no more than 60 wt. %, 55 wt. %, 50 wt. %, 45 wt. %, 40 wt. %, 35 wt. %, 30 wt. %, 25 wt. %, 20 wt. %, 15 wt. % or no more than 10 wt. % by weight of the dry mixture.

The dry mixture may comprise one or more beverage ingredient powders in an amount of from 1-50wt. %, 1-45wt. %, 1-40wt. %, 1-35wt. %, 5-40wt. %, 10-40wt. %, 15-40wt. %, 20-40wt. %, 25-40wt. %, or 30-40wt. % by weight of the dry mixture.

The dry mixture may comprise a sugar in an amount of at least 5wt. %, 10wt. %, or at least 15wt. % by weight of the dry mixture. The dry mixture may comprise a sugar in an amount of no more than 25wt. %, 20wt. %, 19wt. %, 18wt. %, 17wt. %, 16wt. % or no more than 15wt. % by weight of the dry mixture.

The dry mixture may comprise a sugar in an amount of 1-30wt. %, 1-25wt. %, 5-25wt. %, 10-25wt. %, 10-20wt. %, 11-19wt. %, 12-18wt. % or 13-17wt. % by weight of the dry mixture.

The step of spraying the sugar solution may comprise spraying a sugar solution in an amount of at least 1 wt. %, 2 wt. %, 3 wt. %, 4 wt. %, 5 wt. %, 6 wt. %, 7 wt. %, 8 wt. %, 9 wt. %, 10 wt. %, 11, 12 wt. %, 13 wt. %, 14 wt. %, 15 wt. %, or at least 20 wt. % by weight of the coffee product. The step of spraying the sugar solution may comprise spraying a sugar solution in an amount of no more than 30 wt. %, 20 wt. %, 15 wt. %, or no more than 10 wt. % by weight of the coffee product.

The step of spraying the sugar solution may comprise spraying a sugar solution in an amount of from 1-40 wt. %, 1-35 wt. %, 1-30 wt. %, 1-25 wt. %, 5-25 wt. %, 10-25 wt. %, 15-25 wt. %, 15-25 wt. %, 1-20 wt. %, 1-15 wt. %, 1-10 wt. %, 1-9 wt. %, 1-8 wt. %, 1-7 wt. %, 1-6 wt. % or 1-5wt. % by weight of the coffee product.

In some embodiments, the pressure under which the spray of a sugar solution is formed in step a) is at least 1 bar, 2 bar, 3 bar, 4 bar, 5 bar, 6 bar, 7 bar, 8 bar, 9 bar or 10 bar. In some embodiments the pressure under which the spray of liquid instant coffee droplets is formed in step a) is between 1 to 10 bar, 1 to 5 bar, or 5 to 10 bar, preferably between 2 to 5 bar.

In some embodiments, the sugar solution may have a viscosity of at least 5 mPas, 10 mPas, 15 mPas, 20 mPas or 25 mPas. The liquid instant coffee may have a viscosity of no more than 35 mPas, 30 mPas, 25 mPas or 20 mPas.

The sugar solution may have a viscosity of 5 -35 mPas, 5-30 mPas, 10-30 mPas, 15-30 mPas, 20-30 mPas, 10-25 mPas or 10-20 mPas.

Step a) of spraying the sugar solution may have a time of at least 3 minutes, 4, minutes, 5 minutes, 6 minutes, 7 minutes or 8 minutes. In some embodiments, step a) may have a time of no more than 12 minutes, 11 minutes, 10 minutes, 9 minutes or 8 minutes.

Step a) of spraying the sugar solution may have a time of 3-12 minutes, 4-11 minutes, 5-10 minutes, 6-10 minutes, 7-10 minutes, 8-10 minutes, 5-9 minutes, 5-8 minutes or 5-7 minutes.

Embodiments with such parameters have the additional advantage of low level of fines in the coffee product.

The mixture formed in step a) may be mixed in step b) for a period of at least 50 seconds, 60 seconds, 70 seconds, 80 seconds, 90 seconds, 100 seconds, 110 seconds, 120 seconds, 130 seconds 140 seconds 150 seconds, 160 seconds, 170 seconds, 180 seconds, 200 seconds, 225 seconds, 250 seconds, 275 seconds, 300 seconds, 325 seconds, 350 seconds, 375 seconds, 400 seconds, 425 seconds, 450 seconds, 475 seconds, 500 seconds, 525 seconds, 550 seconds, 575 seconds, or 600 seconds.

It has been observed that such mixing times enables the roast and ground coffee particles to have a more uniform coating of the one or more beverage ingredient powders and a sugar. This improves the solubility of the coffee product during brewing.

Step b) may have a tip speed of at least 0.5, 0.6, 0.7, 0.8, 0.9, 1.0, 1.1, 1.2, 1.3, 1.4, 1.5, 1.6, 1.7, 1.8, 2.0 m/s, 2.2, 2.4 or 2.5 m/s. In some embodiments, step b) may have a tip speed of no more than 5.0, 4.8, 4.6, 4.4, 4.2, 4.0, 3.8, 3.6, 3.4, 3.2, 3.0, 2.8, 2.6, 2.4, 2.2 or 2.0 m/s.

Step b) may have a tip speed of 0.5-5 m/s, 0.5-4 m/s, 0.5-3 m/s, 0.5-2.5 m/s, 0.5-2.0 m/s, 1.0-2.0 m/s, 1.2-2 m/s, 1.4-2.0 m/s or 1.5-2.0 m/s.

It has been observed that such mixing speeds increases the density of the coffee product. This improves the solubility of the coffee product and increases the fill weight of the coffee product.

The process may further comprise the step of densifying the coated roast and ground coffee particles.

The step of densifying the coated roast and ground coffee particles may be before step c).

The step of densifying the coated roast and ground coffee particles may be before step c) and after step b).

The densification of the coated roast and ground coffee particles forms stronger and more dense agglomerates of coated roast and ground coffee. These stronger and/or more dense agglomerates are less likely to break up. Without being bound by theory, it is thought that densification of the coated roast and ground coffee particles allows water to be better distributed over the coated coffee particles during brewing, thereby improving solubility.

Moreover, the densification step increases the density of the coffee product, thereby increasing the total amount of coffee product that can be added to a container, such as a capsule.

The step of densifying the coated roast and ground coffee particles may comprise increasing the density of the coated roast and ground coffee particles.

The step of densifying the coated roast and ground coffee particles may comprise increasing the density of the coated roast and ground coffee particles to at least 250, 300, 350 g/l or 400 g/l and/or no more than 850, 650 or 600 g/l and/or between 250-850 g/l; 35-850 g/l; 250-600 g/l or 350-600 g/l.

In some embodiments, the step of densifying the roast and ground coffee may comprise increasing the density of the coated roast and ground coffee particles to at least 200 g/l, 205 g/l, 210 g/l, 215 g/l, 220 g/l, 225 g/l, 230 g/l, 235 g/l, 240 g/l, 245 g/l, 250 g/l, 255 g/l, 260 g/l, 265 g/l, 270 g/l, 270 g/l, 275 g/l, 280 g/l, 285 g/l,290 g/l, 295 g/l, 300 g/l, 305 g/l, 310 g/l, 315 g/l, 320 g/l, 325 g/l, 330 g/l, 335 l/g,340 l/g, 345 l/g, 350 g/l, 355 g/l, 360 g/l, 365 l/g, 370 g/l, 375 g/l, 380 g/l, 385 g/l, 390 g/l, 395 g/l, or at least 400 g/l.

In some embodiments, the step of densifying the roast and ground coffee may comprise increasing the density of the coated roast and ground coffee particles to no more than 900 g/l, 895 g/l, 890 g/l, 885 g/l, 880 g/l, 875 g/l, 870 g/l, 865 g/l, 860 g/l, 855 g/l, 850 g/l, 845 g/l, 840 g/l, 835 g/l, 830 g/l, 825 g/l, 820 g/l, 815 g/l, 810 g/l, 805 g/l, 800 g/l, 795 g/l, 790 g/l, 785 g/l, 780 g/l, 775 g/l, 770 g/l, 765 g/l, 760 g/l, 755 g/l, 750 g/l, 745 g/l, 740 g/l, 735 g/l , 730 g/l, 725 g/l, 720 g/l, 715 g/l, 710 g/l, 705 g/l, 700 g/l, 695 g/l, 690 g/l, 685 g/l, 680 g/l, 675 g/l, 670 g/l, 665 g/l, 660 g/l, 655 g/l, 650 g/l, 645 g/l, 640 g/l, 635 g/l, 630 g/l, 625 g/l, 620 g/l, 615 g/l, 610 g/l, 605 g/l, 600 g/l, 595 g/l , 590 g/l, 585 g/l, 580 g/l, 575 g/l, 570 g/l, 565 g/l, 560 g/l, 555 g/l, 550 g/l, 545 g/l, 540 g/l, 535 g/l, 530 g/l, 525 g/l, 520 g/l, 515 g/l, 510 g/l, 505 g/l, or no more than 500 g/l.

In some embodiments, the step of densifying the roast and ground coffee may comprise increasing the density of the coated roast and ground coffee particles to from 225-625 g/l, 230-620 g/l, 235-615 g/l, 240-610 g/l, 245-605 g/l, 250-600 g/l, 255-595 g/l, 260-590 g/l, 265-585 g/l, 270-580 g/l, 275-575 g/l, 280-570 g/l, 285-565 g/l, 290-560 g/l, 295-555 g/l, 300-550 g/l, 305-545 g/l, 310-540 g/l, 315-535 g/l, 320-530 g/l, 325-525 g/l, 330-520 g/l, 335-515 g/l, 340-510 g/l, 345-505 g/l, 350-500 g/l, 355-495 g/l, 360-490 g/l, 365-485g/l, 370-480 g/l, 375-475 g/l, 380-470 g/l, 385-465 g/l, 390-460 g/l, 395-455 g/l, 400-450 g/l, 400-600 g/l, 405-595 g/l, 410-590 g/l, 415-585 g/l, 420-580 g/l, 425-575 g/l, 430-570 g/l, 435-565 g/l, 440-560 g/l, 445-555g/l, 450-550 g/l, 400-600 g/l, 405-595 g/l, 410-590 g/l, 415-585 g/l, 420-580 g/l, 425-575 g/l, 430-570 g/l, 435-565 g/l, 440-560 g/l, 445-555 g/l, 450-550 g/l, 450-545 g/l, 450-540 g/l, 450-535 g/l, 450-530 g/l, or from 450-525 g/l.

The step of densifying the coated roast and ground coffee particles may comprise subjecting the coated roast and ground coffee particles to shear mixing.

The shear mixing may be high shear mixing and/or low shear mixing.

The step of densifying the one or more coated roast and ground coffee particles may be carried out for at least 50 seconds, 60 seconds, 70 seconds, 80 seconds, 90 seconds, 100 seconds, 110 seconds, 120 seconds, 130 seconds 140 seconds 150 seconds, 160 seconds, 170 seconds, or 180 seconds, 200 seconds, 250 seconds, 300 seconds, 350 seconds, 350 seconds, 400 seconds, 450 seconds, 500 seconds or at least 550.

The step of densifying the one or more coated roast and ground coffee particles may be carried out simultaneously with step b).

Alternatively, the step of densifying the one or more coated roast and ground coffee particles may be carried out after step b) and before step c).

The process may further comprise a step of filling a mixing device with roast and ground coffee particles.

The step of filling the mixing device may be before step a).

The step of filling the mixing device may comprise filling the mixing device to at least 10%, 20%, 30%, 40%, 45%, 50%, 55%, 60%, 65% 70%, 75% 80, or 90% of its total volume. The step of filling the mixing device may comprise filling the mixing device to no more than 90%, 80%, 70%, 65%, 60%, 55%, 50%, 45%, 40%, or 30% of its total volume.

In some embodiments, the step of filling the mixing device may comprise filling the mixing device to from 53-60%, 54-60%, 54-60%, 50-59%, 50-58%, 50-57%, 50-56%, or 50-55% of its total volume.

The inventors discovered that if the mixing device is not filled to its total volume, the step of densifying the coated roast and ground coffee particles may result in fluidised particle motion. This may result in the formation of a mechanically induced fluidised bed.

Beneficially, the partial filling of the mixing device allows improved control of the density of the final product. For example, partial filling of the mixing device may provide a lower density product, whereas the complete filling of the mixing device may provide a higher density product.

Therefore, the step of densifying the coated roast and ground coffee particles may comprise mechanically fluidising a bed of the coated roast and ground coffee particles.

The mixing device may be a granulator.

The mixing device may be a high shear granulator or a low shear granulator.

Preferably, the mixing device is a high shear granulator.

Beneficially, a high shear granulator is able to carry out at least steps a) to c) and preferably all of the process steps in one device. Moreover, a high shear granulator has been found to provide a coffee product with an appropriate friability and density.

In some embodiments, the step of filling the mixing device may comprise filling the mixing device to 10-90%, 20-80%, 30-70%, 40-70%, 45-70%, 45-65%, 45-60%, 45-55%, 50-60%, 45-60%, 46-60%, 47-60%, 48-60%, 49-60%, 50-60%, 51-60%, 52-60%,

According to a third aspect of the invention, there is provided a container comprising the coffee product of the first aspect of the invention.

The container is preferably a coffee preparation machine insertable container.

In some embodiments, the coffee preparation machine insertable container is selected from: a capsule, a disc, a pod, a pad, a semi-rigid pad, a filter bag, a pouch, a cartridge.

In some embodiments, the container has a volume of at least 5 ml, 10ml, 25 ml, 50ml, 75 ml, 100 ml, 150ml, 175 ml, 200 ml, 225 ml, 250 ml, 275 ml, 300 ml, or at least 325 ml. Preferably, the container has a volume of between 50-350ml. In more preferred, embodiments, the beverage preparation machine insertable beverage ingredient container comprises a coffee preparation machine-readable portion.

Embodiments with such container volumes have the additional advantages of compatibility with beverage preparation machines, such as coffee machines.

In some embodiments, the coffee product occupies at least 45%, 50%, 55%, 60%, 65%, 70%, 75% or 80% and/or no more than 95% or 90% of the total volume of the container. In some preferred embodiments the coffee product occupies between 45%-95%, or between 55%-95%, or between 65%-95%, or between 75%-95%, or between 45%-90%, or between 55%-90%, or between 65%-90% or between 75% 90% of the total volume of the container.

The preferred ranges of the density and median particle size described above for the first aspect of the invention enable significant volume of filling, whilst also preventing blocking of the container and providing improved solubility. This allows the container to provide a beverage improved texture and concentration whilst having a reduced amount of undesirable leftover residue of wetted powder.

According to a fourth aspect of the invention there is provided a method of preparing a container of a third aspect of the invention comprising steps of:
a) providing a coffee product produced according to the first aspect of the present invention; and
b) adding the coffee product to a container according to the third aspect of the present invention.

In some embodiments, the container is subsequently sealed, preferably by heat sealing. A heat-sealed closure has the particular advantage of being readily pierced in order to extract the contents of the container in conjunction with a beverage preparation machine.

According to a fifth aspect of the invention, there is provided a method of preparing a beverage comprising the steps of;
a) providing a container of the third aspect of the invention;
b) transporting fluid through the container; and
c) dissolving and/or suspending at least some of the coffee product in the fluid such that fluid exiting the container comprises at least a portion of the coffee product extracted, dissolved and/or suspended therein.

In some embodiments, the volume of fluid transport in step b) is at least 10ml, 25 ml, 50ml, 75 ml, 100 ml, 150ml, 175 ml, 200 ml, 225 ml, 250 ml, 275 ml, 300 ml, or at least 325 ml.

The volume of fluid transport in step b) may, for example be between 50 ml 350 ml.

In some embodiments, the fluid transported in step b) is transported under a pressure of less than 25 bar, 22 bar, 20 bar, 18 bar, 16 bar, 14 bar, 12 bar, 10 bar, 8 bar, 6 bar, 4 bar, 3 bar or 2 bar. In some embodiments, the fluid is transported in step b) under a pressure of at least 0.5 bar, 1 bar or 2 bar. Preferably, the fluid is transported at a pressure of 0.5-3 bar, 1-3 bar or 1-2 bar.

The time taken for steps b) to c) may be less than 300 seconds, less than 275seconds, less than, 250 seconds, less than 225 seconds, less than 200 seconds, less than 190 seconds, less than 180 seconds, less than 175 seconds, less than 170 seconds, less than 165 seconds, less than 160 seconds, less than 155 seconds, less than 150 seconds, less than 145 seconds, less than 140 seconds, less than 135 seconds, less than 130 seconds, less than 125 seconds, less than 120 seconds, less than 115 seconds, less than 110 seconds, less than 105 seconds, less than 100 seconds, less than 95 seconds, less than 90 seconds, less than 85 seconds, less than 80 seconds, less than 75 seconds, less than 70 seconds, less than 65 seconds, less than 60 seconds, less than 55 seconds, less than 50 seconds, less than 45 seconds, less than 40 seconds, less than 35 seconds, less than 30 seconds, or less than 25 seconds.

The beverage may have a total dissolved solids amount of at least 0.5 %, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.1%, 3.2%, 3.3%, 3.4%, 3.5%, 3.6%, 3.7%, 3.8%, 3.9%, 4%, 4.1%, 4.2%, 4.3%, 4.4%, 4.5%, 4.6%, 4.7%, 4.8%, 4.9%, 5% or 5.1%, 5.2%, 5.3%, 5.4%, 5.5%, 5.6%, 5.7%, 5.8%, 5.9% or at least 6%. Preferably, the beverage may have an amount of total dissolved solids of 1.0-7.0%, 1-7.0%, 2-7.0%, 2.5-7.0%, 3.0-7.0%, 3.5-7.0%, 4.0-7.0%, 4.0-6.5, 4.5-6.5%, 5.0-6.5%, or 5.0-6.0%.

In some embodiments, the amount of beverage ingredient left as residue in the beverage ingredient container, after the beverage has been prepared is less than 20%, 15%, 10%, 5% or 2.5% of the starting volume or weight of the ingredient.

Such low residues have the advantage of low waste of beverage ingredient powder and reduced need for addition of excess beverage ingredient powder such that sufficient powder is transported into the beverage. They also have the advantage of more desirable beverages with more in cup solids resulting in better mouthfeel and taste.

Preferably, the beverage is a brewed coffee.

According to a sixth aspect of the invention, there is provided a coffee product produced according to the first aspect of the present invention for use in a beverage preparation machine.

Preferably, the beverage preparation machine is a coffee preparation machine.

The further aspects of the present invention may incorporate any of the features of the other aspects of the invention described herein as desired or as appropriate.

### DETAILED DESCRIPTION OF THE INVENTION

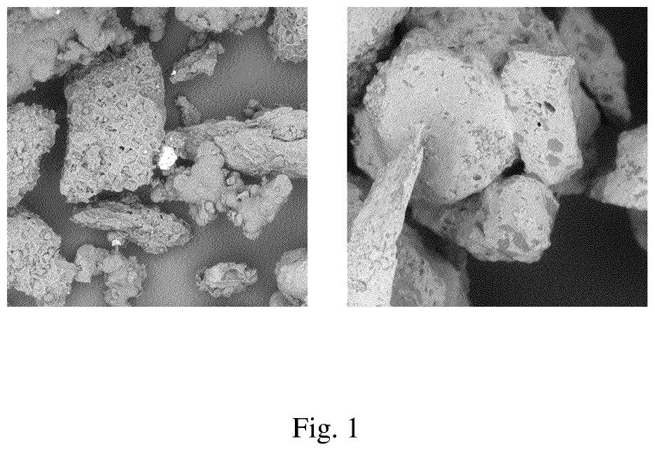

In order that the invention may be more clearly understood one or more embodiments thereof will now be described, by way of example only, with reference to the accompanying drawings, of which:
FIG. 1 is a schematic of the process of the present invention.

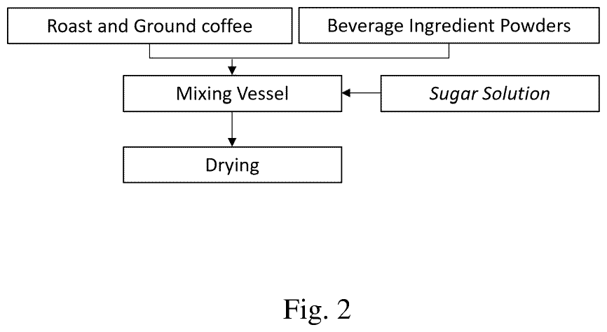

FIG. 2 shows a Scanning electron microscope (SEM) image 240× magnification of a coated coffee product according to the present invention (right) and a Scanning electron microscope (SEM) image 250× magnification of a dry mixture of the ingredients of the coffee product prior to coating (left).

### Examples

Coffee products were prepared according to the first aspect of the present invention as set out below.

### Example 1

A dry mixture comprising roast and ground coffee particles in an amount of 47.2 wt. % by weight of the dry mixture, creamer in an amount of 36.8wt. % by weight of the dry mixture, sugar 15.4 wt. % by weight of the dry mixture, salt in an amount of 0.3 wt. % by weight of the dry mixture and flavouring in an amount of 0.3 wt. % by weight of the dry mixture were placed inside a Lödige L5 granulator operating at a spray pressure of 5 bar and a tip speed of 2 m/s. Additional sugar in an amount of 5 wt. % by weight of the coffee product was sprayed onto the dry mixture in a 40% sugar solution. The spraying of the sugar solution and shear created by the mixing impeller of the granulator, resulted in roast and ground coffee particles coated with creamer, salt, flavouring and sugar. The coated roast and ground coffee particles were then dried using a Neuhaus Neotec LFB mini L dryer to form a coffee product of the present invention.

The coffee product of Example 1 had a median particle size of 940 μm, a bulk density of 513 g/l and comprised roast and ground coffee particles in an amount of 45 wt. % by weight of the coffee product and creamer in an amount of 35 wt. % by weight of the coffee product, flavouring in an amount of 0.3 wt. % by weight of the coffee product, a sugar in an amount of 20% by weight of the coffee product and salt in an amount of 0.3 wt. % by weight of the coffee product.

As shown in FIG. 2, the coffee product did not possess significant fines (0.3% fines<100 μm) and the roast and ground coffee particles were coated with a uniform layer of beverage ingredient powder and sugar.

18.5 g of the coffee product of Example 1 was then packed into standard bottom and top Senseo filter pad without plastic insert and brewed using a Senseo Original beverage preparation machine and the double pad holder. The machine provides water heated to between 85 and 95° C. and a target drink volume of 120 ml. The coffee product had a solids content of 5-6% and a solubility of 50-60%.

The coffee product showed improved solubility when compared with a similar mixture of the ingredients without coating and provided a brew with a strong coffee intensity and smooth texture, together with a reduced amount of leftover residue of wetted powder. Moreover, the coffee product was able to successfully brew without the need for any additional inserts to improve solubility, thereby reducing waste and costs. The above embodiment is described above by way of example only. Many variations are possible without departing from the scope of protection afforded by the appended claims.

1. A coffee product comprising roast and ground coffee particles coated with one or more beverage ingredient powders and a sugar.

2. A product according to claim 1, wherein the one or more beverage ingredient powders are selected from the group consisting of instant coffee powder, a chocolate beverage powder, a milk powder, dairy creamer, or a non-dairy creamer powder.

3. A product according to claim 1, wherein the sugar is selected from the group consisting of glucose, sucrose, fructose, galactose, lactose or maltose.

4. A product according to claim 1, wherein the coffee product comprises roast and ground coffee in an amount of from 15-70 wt. %, 15-65 wt. %, 20-65 wt. %, 25-65 wt. %, 30-65 wt. %, 35-65 wt. %, 35-60 wt. %, 40-60 wt. %, or 40-55 wt. % by weight of the coffee product.

5. A product according to claim 1, wherein the coffee product comprises one or more beverage ingredient powders in an amount of from 15-45 wt. %, 20-40 wt. %, 25-45 wt. %, or 30-40 wt. % by weight of the coffee product.

6. A product according to claim 1, wherein the coffee product comprises a sugar in an amount of from 1-30 wt. %, 1-25 wt. %, 5-25 wt. %, 10-25 wt. %, or 15-25 wt. % by weight of the coffee product.

7. A product according to claim 1, wherein the coated roast and ground coffee particles of the coffee product have a surface covered by at least 50%, 55%, 60%, 65%, 70%, 75%, 80%, 85%, 90%, or 99% of the one or more beverage ingredient powders and a sugar.

8. A product according to claim 1, wherein the mean density of the coffee product is between 250-850g/1 350-850g/1, 250-600g/l, 350-600 g/l, 400-600 g/l, 450-600 g/l, or 450-550 g/l.

9. A process for manufacturing a coffee product comprising the steps of:
a) spraying a sugar solution onto a dry mixture comprising roast and ground coffee particles and one or more beverage ingredient powders to coat the roast and ground coffee particles with one or more beverage ingredient powders and a sugar.
b) mixing the mixture formed in step a); and
c) drying the coated roast and ground coffee particles to form a coffee product comprising roast and ground coffee particles coated with one or more beverage ingredient powders and a sugar.

10. A process according to claim 9, wherein the dry mixture comprises roast and ground coffee in an amount of from 15-65 wt. %, 20-65 wt. %, 25-65 wt. %, 30-65 wt. %, 35-65 wt. %, 40-65 wt. %, or 45-55 wt. % by weight of the dry mixture.

11. A process according to claim 9, wherein the dry mixture comprises one or more beverage ingredient powders in an amount of from 15-40 wt. %, 20-40 wt. %, 25-40 wt. %, or 35-40 wt. % by weight of the dry mixture.

12. :A process according to claim 9, wherein the step of spraying the sugar solution comprises spraying a sugar solution in an amount of from 5-25 wt. %, 10-25 wt. %, 15-25 wt. %, 15-25 wt. %, 1-20 wt. %, 1-15 wt. %, 1-10 wt. %, 1-9 wt. %, 1-8 wt. %, 1-7 wt. %, 1-6 wt. % or 1-5 wt. % by weight of the coffee product.

13. A process according to claim 9, wherein the process further comprises the step of densifying the coated roast and ground coffee particles and wherein the step of densifying the coated roast and ground coffee particles is performed before step c).

14. A process according to claim 9, wherein the process further comprises a step of filling a mixing device with the dry mixture and wherein the step of filling the mixing device is before step a).

15. A process according to claim 14, wherein the mixing device is a granulator.

16. : A container comprising the coffee product of claim 1.

17. A container according to claim 19, wherein the container is a pod.

18. A method of preparing a container comprising steps of:
a) providing a coffee product produced according to claim 1;
and b) adding the coffee product to the container.

19. A method of preparing a beverage comprising the steps of;
a) providing a container according to claim 16;
b) transporting fluid through the container; and
c) dissolving and/or suspending at least some of the coffee product in the fluid such that fluid exiting the container comprises at least a portion of the coffee product extracted, dissolved and/or suspended therein.

20. A method according to claim 19, wherein the volume of fluid transport in step b) is between 50 ml-350 ml.

21. A method according to claim 19, wherein the, the fluid is transported at a pressure of at least 1 bar.

22. A method according to claim 19, wherein the time taken for steps b) to c) is less than 200 seconds, less than 180 seconds, less than 100 seconds, less than 60 seconds or less than 25 seconds.

23. A method according to claim 19, wherein the beverage may have a total dissolved solids amount of at least 1%, 2%, 3%, 4% or 5%.

24. A coffee product according to claim 1, for use in a beverage preparation machine.
